(19) United States
(12) Patent Application Publication
(10) Pub. No.: US 2013/0128367 A1
(43) Pub. Date: May 23, 2013

(54) ELECTRODE STRUCTURE FOR DIELECTRIC LIQUID LENS

(71) Applicants: Chih-Wei Tsai, Hsinchu City (TW); Jer-Liang Yeh, Hsinchu City (TW)

(72) Inventors: Chih-Wei Tsai, Hsinchu City (TW); Jer-Liang Yeh, Hsinchu City (TW)

(73) Assignee: NATIONAL TSING HUA UNIVERSITY, Hsinchu City (TW)

(21) Appl. No.: 13/492,575

(22) Filed: Jun. 8, 2012

(30) Foreign Application Priority Data
Nov. 23, 2011 (TW) 100142828

(51) Int. Cl. G02B 3/14

(52) U.S. Cl. 359/666

(57) ABSTRACT

An electrode structure, applied to a liquid lens, comprises: a first annular body; a plurality of first connecting parts, connected to the first annular body and extended radially outward from the center of the first annular body; a second annular body; and a plurality of the second connecting parts, connected the second annular body and extended radially inward into the center of the second annular body. Wherein, the first annular body and the second annular body are on the same plane, the center of the first annular body is concentric with the center of the second annular body, the first connecting parts and the second connecting parts are mutually interlaced and arranged in circular permutation.

### PRIORITY CLAIM

This application claims the benefit of the filing date of Taiwan Patent Application No. 100142828, filed Nov. 23, 2011, entitled “ELECTRODE STRUCTURE FOR DIELECTRIC LIQUID LENS,” and the contents of which is hereby incorporated by reference in its entirety.

### FIELD OF THE INVENTION

The present invention relates to an electrode structure, and more particularly, the present invention is an electrode structure utilized for dielectric liquid lens.

### BACKGROUND OF THE INVENTION

With the development of modern technology, consumer electronic products have been widely spread, meanwhile, electronic products also became thinner and lighter to go with the tide. Wherein, digital cameras and intelligent mobile phones are the most common electronic products. In the conventional camera, zoom system is one of the main factors that affect the image quality. The conventional zoom system is composed of lens group, precision stepping motor, and some mechanical construction. The distance between the lenses can be adjusted by the precision stepping motor, so that users can control the zoom function. However, the mechanical zoom system is restricted to magnifying the area on-axis, and also occupies more space, thus it is hard to utilize for the application of mobile phones. Therefore, the conventional zoom lens have been superseded by dielectric liquid lens, and become the core element of mobile phones.

Dielectric liquid lens employs two liquids in the lens cell, wherein the two liquids are immiscible and non-electrically conductive dielectrics. When the liquid of high refractive index drops on the electrode substrate, a spherical droplet having the optical characteristics of spherical lens would be formed by surface tension. With applying an electric field to the dielectric liquid, the liquid bears a dielectric force and its surface profile can be reshaped which causes the focal length to change.

In the prior art, the driving electrode structures of dielectric liquid lens are concentric rings, as shown in FIG. 1, an electric field with axial symmetry is generated near the bottom of electrode substrate. Due to the strength of dielectric force is directly proportional to square of electric field intensity, the structures of concentric rings can allow the spherical droplet to bear the dielectric force with axial symmetry, so that the center of strained droplet can maintain the same as the geometric center of concentric rings to feed the needs of optical application. However, with the structures of concentric rings, the deformation speed of droplet is still too slow and the displacement distance is too long, causing the reaction time of dielectric liquid lens to be greater. Therefore, how to improve the electrode structures is a challenge.

### SUMMARY OF THE INVENTION

Therefore, a scope of the invention is to provide an electrode structure, applied to a liquid lens. The electrode structure comprises: a first annular body, a plurality of first connecting parts, a second annular body, and a plurality of the second connecting parts. Wherein, the plurality of first connecting parts are connected to the first annular body and extended radially outward from the center of the first annular body; the plurality of the second connecting parts are connected the second annular body and extended radially inward into the center of the second annular body; additionally, the first annular body and the second annular body are on the same plane, the center of the first annular body is concentric with the center of the second annular body, and the first connecting parts and the second connecting parts are mutually interlaced and arranged in circular permutation.

Furthermore, each first connecting part comprises a plurality of first substructures, and each second connecting part comprises a plurality of second substructures.

Wherein, the plurality of first substructures extend outward from the corresponding first connecting parts and encircle the center of the first annular body to form a plurality of concentric rings; the plurality of second substructures can extend outward from the corresponding second connecting parts, encircling the center of the second annular body to form a plurality of concentric rings, and mutually interlaced with the plurality of first substructures.

Besides, the plurality of first substructures extend outward from the corresponding first connecting parts and encircle the center of the first annular body to form a plurality of concentric rings; the plurality of second substructures can be indented inward from the corresponding second connecting parts, and mutually interlaced with the plurality of first substructures.

In conclusion, with the structural design of the plurality of first and second connecting parts, the electrode structure of present invention can improve the deformation speed of droplet so as to decrease the reaction time of dielectric liquid lens. Moreover, with the plurality of concentric rings, the electric field can be controlled and the focal length can be adjusted more precisely.

Many other advantages and features of the present invention will be further understood by the detailed description and the accompanying sheet of drawings.

### BRIEF DESCRIPTION OF THE DRAWINGS

FIG. 1 is a schematic diagram illustrating an electrode structure of dielectric liquid lens in the prior art.

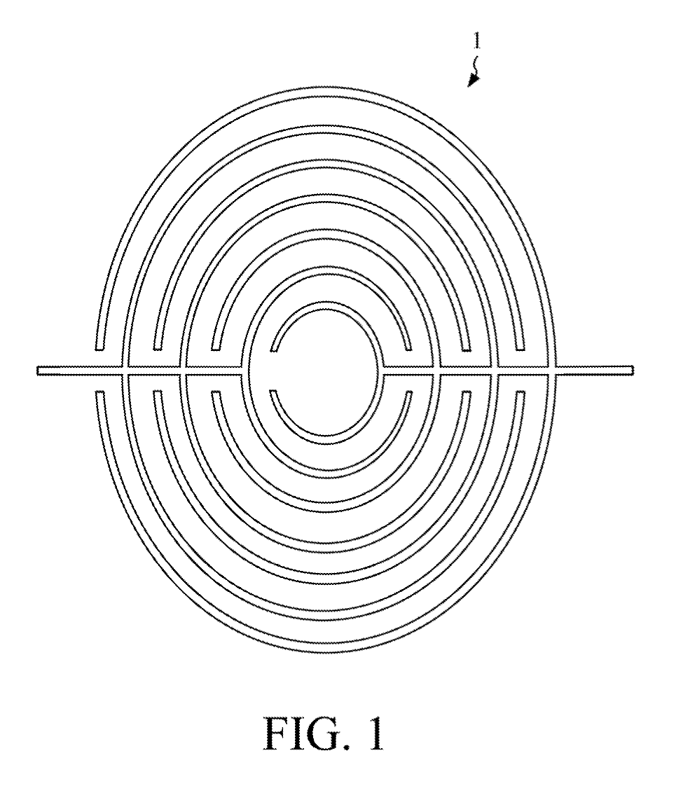

FIG. 2 is a schematic diagram illustrating an electrode structure according to an embodiment of the present invention.

FIG. 3 is a schematic diagram illustrating an electrode structure according to another embodiment of the present invention.

FIG. 4 is a schematic diagram illustrating an electrode structure according to another embodiment of the present invention.

FIG. 5 is a schematic diagram illustrating an electrode structure according to another embodiment of the present invention.

To facilitate understanding, identical reference numerals have been used, where possible to designate identical elements that are common to the figures.

### DETAILED DESCRIPTION

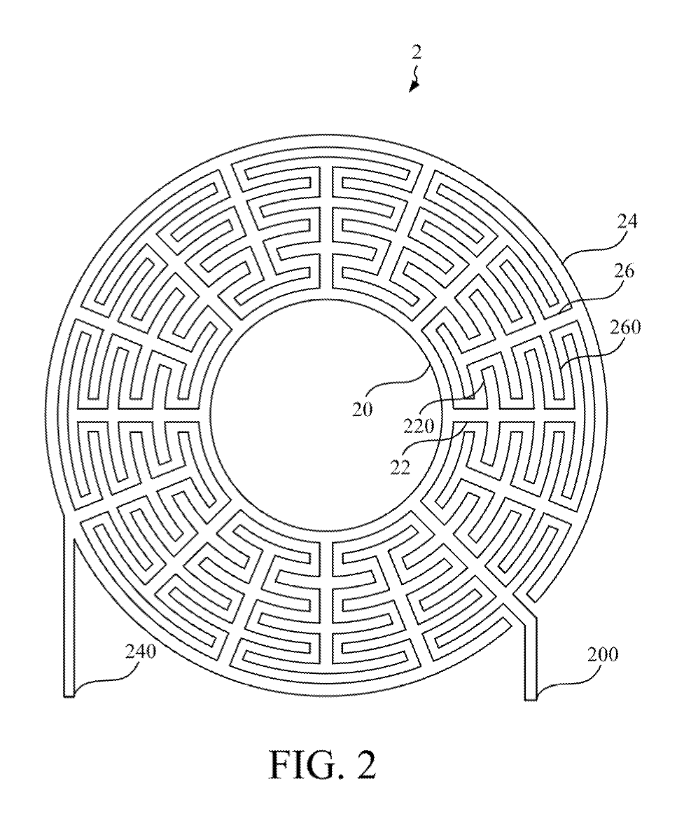

Please refer to FIG. 2. FIG. 2 is a schematic diagram illustrating an electrode structure according to an embodiment of the present invention. As shown in FIG. 2, the invention discloses an electrode structure 2, applied to a liquid lens. The electrode structure 2 comprises: a first annular body 20, a plurality of first connecting parts 22, a second annular body 24, and a plurality of the second connecting parts 26. Wherein, the plurality of first connecting parts 22 are connected to the first annular body 20 and extended radially outward from the center of the first annular body 20; the plurality of the second connecting parts 26 are connected the second annular body 24 and extended radially inward into the center of the second annular body 24; additionally, the first annular body 20 and the second annular body 24 are on the same plane, the center of the first annular body 20 is concentric with the center of the second annular body 24, and the first connecting parts 22 and the second connecting parts 26 are mutually interlaced and arranged in circular permutation.

In an embodiment of the present invention, the first annular body 20 and the second annular body 24 are circular forms. Wherein, the electrode structure 2 comprises eight first connecting parts 22, and each first connecting part 22 is a strip, encircling the periphery of the first annular body 20; the electrode structure 2 also comprises eight second connecting parts 26, and each second connecting parts 26 is a strip, encircling the inner circle of the second annular body 24. Moreover, the first annular body 20 is smaller than the second annular body 24, therefore, when the first annular body 20 and the second annular body 24 are configured on the same plane, and the center of the first annular body 20 is concentric with the center of the second annular body 24, the first connecting parts 22 and the second connecting parts 26 would be mutually interlaced and arranged in circular permutation between the periphery of the first annular body 20 and the inner circle of the second annular body 24 without overlap.

In actual application, the first annular body 20 and the second annular body 24 are, including but not limited to, circles, ovals, rectangles or other geometry structures. But the first connecting parts 22 and the second connecting parts 26 should still be mutually interlaced and arranged in circular permutation between the periphery of the first annular body 20 and the inner circle of the second annular body 24. And that, the number of the first connecting parts 22 and the second connecting parts 26 are, including but not limited to be eight, the number can be increased or decreased depending on requirements.

Additionally, please refer to FIG.2 again. As shown in FIG. 2, each first connecting part 22 comprises a plurality of first substructures 220, and each second connecting part 26 comprises a plurality of second substructures 260. Wherein, the plurality of first substructures 220 extend outward from the corresponding first connecting parts 22 and encircle the center of the first annular body 20 to form a plurality of concentric rings; the plurality of second substructures 260 extend outward from the corresponding second connecting parts 26, encircling the center of the second annular body 24 to form a plurality of concentric rings, and mutually interlaced with the plurality of first substructures 220.

In the embodiment, each first connecting part 22 extends from the periphery of the first annular body 20 to the inner circle of the second annular body 24 so as to form the plurality of first substructures 220, moreover, the first substructures 220 which have the same distance to the center of the first annular body 20 can be arranged in circular permutation and further to form the structure of concentric rings. In the same way, each second connecting part 26 extends from the periphery of the second annular body 24 to the inner circle of the first annular body 20 so as to form the plurality of second substructures 260, moreover, the second substructures 260 which have the same distance to the center of the second annular body 24 can be arranged in circular permutation and further to form the structure of concentric rings. In addition, each first substructure 220 which has different distance to the center of the first annular body 20 and each second substructure 260 which has different distance to the center of the second annular body 24 would form the plurality of concentric rings with inequality in size.

Furthermore, due to the first connecting parts 22 and the second connecting parts 26 are mutually interlaced with each other, the structures of the plurality of concentric rings formed by the first substructures 220 are discontinuous, and there is a second connecting part 26 in the intervals between each two first substructure 220. However, due to the second connecting parts 26 are thin and narrow, the intervals between each two first substructure 220 are also thin and narrow, but with enough space to form the concentric rings. By the same token, the structures of the plurality of concentric rings formed by the second substructures 260 are also discontinuous, and there is a first connecting part 22 in the intervals between each two second substructure 260. Moreover, the first connecting parts 22 are thin and narrow, therefore the intervals between each two second substructure 260 are also thin and narrow, but with enough space to form the concentric rings.

In the embodiment, the first annular body 20 comprises a first end socket 200, and the second annular body 24 comprises a second end socket 240. Wherein, the first end socket 200 extends from the first annular body 20, utilized for connecting to anode; the second end socket 240 extends from the second annular body 24, utilized for connecting to cathode. In actual application, the positions of anode and cathode can be changed reciprocally, i.e., the first end socket 200 can be connected to cathode and the second end socket 240 can be connected to anode.

Compared to the prior art, with the structural design of the plurality of first connecting parts 22 and second connecting parts 26, the electrode structure 2 of present invention can improve the deformation speed of droplet so as to decrease the reaction time of dielectric liquid lens. Moreover, with the plurality of concentric rings, the electric field can be controlled and the focal length can be adjusted more precisely.

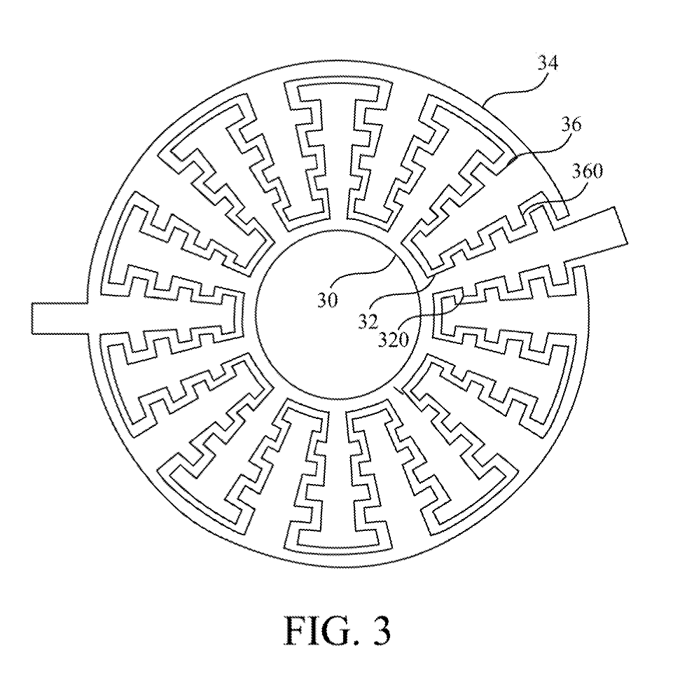

Please refer to FIG.3. FIG. 3 is a schematic diagram illustrating an electrode structure according to another embodiment of the present invention. In the embodiment, the electrode structure 2 of present invention comprises: a first annular body 30, a plurality of first connecting parts 32, a second annular body 34, and a plurality of the second connecting parts 36, a plurality of first substructures 320, and a plurality of second substructures 360. The plurality of first connecting parts 32 are connected to the first annular body 30 and extended radically outward from the center of the first annular body 30; the plurality of the second connecting parts 36 are connected the second annular body 34 and extended radically inward into the center of the second annular body 34; additionally, the first annular body 30 and the second annular body 34 are on the same plane, the center of the first annular body 30 is concentric with the center of the second annular body 34, and the first connecting parts 32 and the second connecting parts 36 are mutually interlaced and arranged in circular permutation. In addition, each first connecting part 32 comprises a plurality of first substructures 320, and each second connecting part 36 comprises a plurality of second substructures 360. Wherein, the plurality of first substructures 320 extend outward from the corresponding first connecting parts 32 and encircle the center of the first annular body 30 to form a plurality of concentric fines; the plurality of second substructures 360 extend outward from the corresponding second connecting parts 36, encircling the center of the second annular body 34 to form a plurality of concentric rings, and mutually interlaced with the plurality of first substructures 320.

To be noticed, the widths of the first connecting parts 32 are larger than the corresponding widths of the plurality of first substructures 320; and the widths of the second connecting parts 36 are larger than the corresponding widths of the plurality of second substructures 360. Therefore, the electrode structure of present invention can increase the deformation speed of droplet and the electric field can be controlled so as to adjust the focal length more precisely and efficiently.

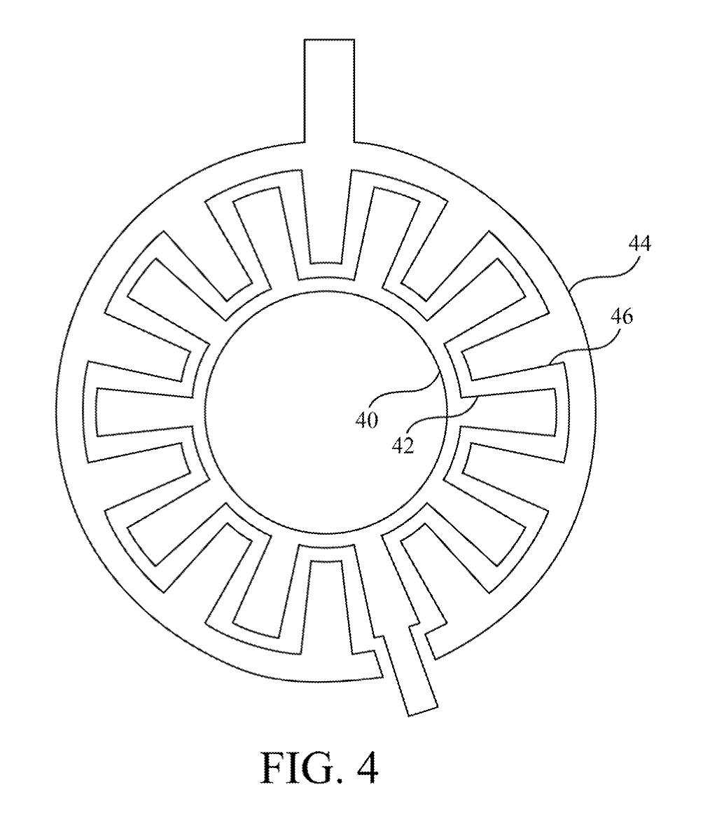

Please refer to FIG. 4. FIG. 4 is a schematic diagram illustrating an electrode structure according to another embodiment of the present invention. In the embodiment, the electrode structure of present invention comprises: a first annular body 40, a plurality of first connecting parts 42, a second annular body 44, and a plurality of the second connecting parts 46. Wherein, the plurality of first connecting parts 42 are connected to the first annular body 40 and extended radically outward from the center of the first annular body 40; the plurality of the second connecting parts 46 are connected the second annular body 44 and extended radically inward into the center of the second annular body 44; additionally, the first annular body 40 and the second annular body 44 are on the same plane, the center of the first annular body 40 is concentric with the center of the second annular body 44, and the first connecting parts 42 and the second connecting parts 46 are mutually interlaced and arranged in circular permutation.

To be noticed, in the embodiment of present invention, the first and second substructures are omitted, meanwhile, the number of the first connecting parts 42 and the second connecting parts 46 can be increased as many as possible. Therefore, the electrode structure of present invention can increase the deformation speed of droplet greatly so as to decrease the reaction time of dielectric liquid lens substantially.

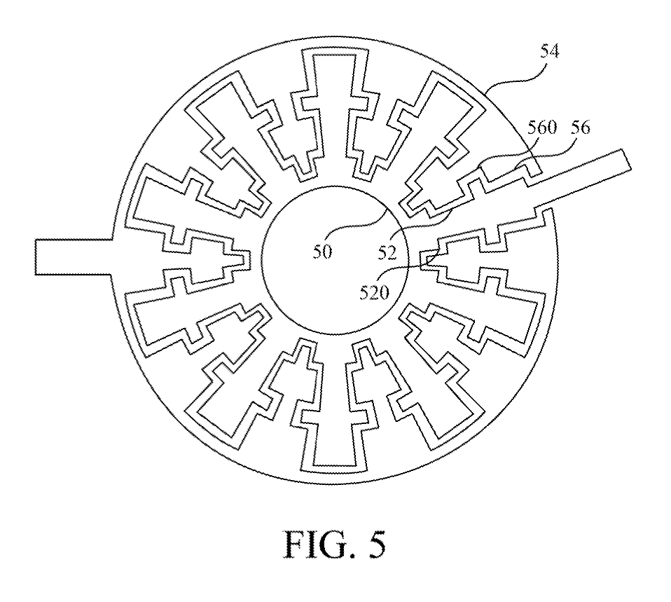

Please refer to FIG. 5. FIG. 5 is a schematic diagram illustrating an electrode structure according to another embodiment of the present invention. In the embodiment, the electrode structure of present invention comprises: a first annular body 50, a plurality of first connecting parts 52, a second annular body 54, and a plurality of the second connecting parts 36, a plurality of first substructures 520, and a plurality of second substructures 560. The plurality of first connecting parts 52 are connected to the first annular body 50 and extended radically outward from the center of the first annular body 50; the plurality of the second connecting parts 56 are connected the second annular body 54 and extended radically inward into the center of the second annular body 54; additionally, the first annular body 50 and the second annular body 54 are on the same plane, the center of the first annular body 50 is concentric with the center of the second annular body 54, and the first connecting parts 52 and the second connecting parts 56 are mutually interlaced and arranged in circular permutation. In addition, each first connecting part 52 comprises a plurality of first substructures 520, and each second connecting part 36 comprises a plurality of second substructures 560. Wherein, the plurality of first substructures 520 extend outward from the corresponding first connecting parts 52 and encircle the center of the first annular body 50 to form a plurality of concentric rings; the plurality of second substructures 560 are indented inward from the corresponding second connecting parts 56, and mutually interlaced with the plurality of first substructures 520.

To be noticed, the second substructures 560 in the embodiment are indented inward but not extend outward from the corresponding second connecting parts 56. Therefore, the structural design of second substructures 560 can be simplified and maintain being mutually interlaced with the first substructures 520, and further allow the concentric rings to have enough space to accommodate more first connecting parts 52 and second connecting parts 56. Meanwhile, the deformation speed of droplet can be increased and the electric field can be controlled so as to adjust the focal length more precisely and efficiently.

In actual application, the substructures can be changed reciprocally, i.e., the plurality of second substructures 560 can extend outward from the corresponding second connecting parts 56 and encircle the center of the second annular body 54 to form a plurality of concentric rings; the plurality of first substructures 520 can be indented inward from the corresponding first connecting parts 52, and mutually interlaced with the plurality of second substructures 560.

According above stated, with the structural design of the plurality of first and second connecting parts, the electrode structure of present invention can improve the deformation speed of droplet so as to decrease the reaction time of dielectric liquid lens. Moreover, with the plurality of concentric rings, the electric field can be controlled and the focal length can be adjusted more precisely. Additionally, with simplifying the structural design of first or second substructures, the concentric rings can have enough space to accommodate more first connecting parts and second connecting parts, so as to increase the deformation speed of droplet greatly and decrease the reaction time of dielectric liquid lens substantially.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An electrode structure, applied to a liquid lens, comprising:
a first annular body;
a plurality of first connecting parts, connected to the first annular body and extended radially outward from the center of the first annular body;
a second annular body; and
a plurality of the second connecting parts, connected the second annular body and extended radially inward into the center of the second annular body;
wherein, the first annular body and the second annular body are on the same plane, the center of the first annular body is concentric with the center of the second annular body, the first connecting parts and the second connecting parts are mutually interlaced and arranged in circular permutation.

2. The electrode structure of claim 1, wherein each first connecting part comprises a plurality of first substructures, and each second connecting part comprises a plurality of second substructures.

3. The electrode structure of claim 2, wherein the plurality of first substructures extend outward from the corresponding first connecting parts and encircle the center of the first annular body to form a plurality of concentric rings; the plurality of second substructures extend outward from the corresponding second connecting parts, encircling the center of the second annular body to form a plurality of concentric rings, and mutually interlaced with the plurality of first substructures.

4. The electrode structure of claim 2, wherein the plurality of first substructures extend outward from the corresponding first connecting parts and encircle the center of the first annular body to form a plurality of concentric rings; the plurality of second substructures are indented inward from the corresponding second connecting parts, and mutually interlaced with the plurality of first substructures.

5. The electrode structure of claim 2, wherein the plurality of second substructures extend outward from the corresponding second connecting parts and encircle the center of the second annular body to form a plurality of concentric rings; the plurality of first substructures are indented inward from the corresponding first connecting parts, and mutually interlaced with the plurality of second substructures.

6. The electrode structure of claim 3, wherein the widths of the first connecting parts are larger than the widths of the plurality of first substructures.

7. The electrode structure of claim 3, wherein the widths of the second connecting parts are larger than the widths of the plurality of second substructures.
